(19) United States
(12) Patent Application Publication
(10) Pub. No.: US 2013/0085873 A1
(43) Pub. Date: Apr. 4, 2013

(54) DELIVERING CLICK-TO-ACTION INTERACTIONS

(71) Applicants: Javier Garcia Puga, Madrid (ES); Andrés Padilla Fuentes, Madrid (ES); Juan Turrion Martin, Madrid (ES)

(72) Inventors: Javier Garcia Puga, Madrid (ES); Andrés Padilla Fuentes, Madrid (ES); Juan Turrion Martin, Madrid (ES)

(21) Appl. No.: 13/635,218

(22) PCT Filed: May 17, 2010
(86) PCT No.: PCT/EP2010/056702

§ 371 Date: Dec. 20, 2012

(30) Foreign Application Priority Data
Mar. 15, 2010 (ES) P201030376

(51) Int. Cl. G06Q 30/02

(52) U.S. Cl. CPC G06Q 30/0277
USPC 705/14.73

(57) ABSTRACT

A system and method are described for causing the delivery of interactions, which are triggered by a user, who is connected to an advertisement server with user equipment via an operator network. The interactions are triggered by the user selecting an advertisement provided by the advertisement server, the interactions entailing capabilities of the operator network. The advertisement server is not provided with the subscriber identifier of the user. For this reason, the system, which is external to the advertisement server, comprises an access module configured for detecting to which operator the user is subscribed, obtaining the subscriber identifier and determining the operator network capabilities in order to deliver the interaction.

### TECHNICAL FIELD

The present invention relates to the field of advertisement systems and more specifically to interactions entailing telecommunication operator capabilities which are carried out immediately after a user clicks on a banner or advertisement related link while browsing the Internet via an Access Point Name (APN)-through connection [http://en.wikipedia.org/wiki/Access_Point_Name]. Such telecommunication operators' APNs are increasingly used to surf the web by mobile devices and laptops equipped with 3G modems.

### DESCRIPTION OF RELATED ART

Advertising throughout the Internet has been since the very beginning a very popular medium for brands to spread their marketing messages to attract consumers. Examples of Internet advertising include contextual advertisements in search engines result pages, e-mail marketing, classified advertising, etc.

But probably the most popular of these online advertisement forms is the web banner (http://en.wikipedia.org/wiki/Banner_ad). A global advertising scenario using web banners 6a, 6b . . . 6n is shown in FIG. 1. This form of advertising entails embedding an advertisement into a web page. It is intended to attract traffic to a website by linking to the website of the advertiser 1a, 1b . . . 1n. The advertisement is usually constructed from an image but as the time goes by more appealing formats are employed to construct banners: JavaScript, Flash, Silverlight, Java, etc.

The web banner is displayed when a web page that references the banner is loaded into a web browser. This event is known as an “impression”. When the viewer clicks on the banner 6a, 6b, 6n, the viewer is directed to the website advertised in the banner 6a, 6b, 6n. This event is known as a “click through”. The page the user is redirected to, once he has clicked, is called the landing page. The landing page will usually display content that is a logical extension of the advertisement or link.

Generally, banners are delivered by an ad(vertisement) server 5. An ad server 5 is a web server that stores advertisements and delivers them to website visitors (http://en.wikipedia.org/wiki/Central_ad_server). The ad server 5 also counts the number of impressions and clicks through for an ad campaign. With those accounting results, reports are generated; the reports help in determining the return of investment for an advertiser 1a, 1b, 1n on a particular website. The ad server 5 and the contents and campaigns it handles are usually managed by traffickers.

Ad servers 5 may be classified in two categories:
Local ad servers are typically run by a single publisher and serve ads to that publisher's domains. The content control is performed by that single publisher.
Remote ad servers can serve ads across domains owned by multiple publishers. They deliver the ads from one central source so that advertisers 1a, 1b, 1n and publishers can track the distribution of their online advertisements.

The spaces where ad servers 5 embed their served ads are named ad spaces (http://www.marketingterms.com/dictionary/ad_space). Ad spaces were not a factor in the earliest days of Web design, but they are now a major factor for sites that are dependent on advertising revenues. One of the challenges of Web design is to use ad space in a way that delivers for advertisers 1a, 1b, 1n without alienating visitors.

The whole number of ad spaces correspond to what it is referred as the ad inventory. This inventory can be found on websites, in RSS feeds, on blogs, in instant messaging applications, in adware, in e-mails, and on other sources. The inventory contains the ads which advertisers 1a, 1b, 1n wish to run. This connection between advertisers 1a, 1b, 1n and publishers wanting to host advertisements takes place through an advertisement network company.

An advertiser 1a, 1b, 1n can buy a package of impressions on the advertising network 2. The advertising network 2 serves advertisements from its ad server 5. The ad server 5 responds to a site once a web page is called.

Large publishers often sell only their remnant inventory through ad networks. Smaller publishers often sell their entire inventory through ad networks. Ad networks make use of technology platforms for buying, selling and bidding for online ad impressions. These platforms are referred as Ad exchanges 3.

Many ad networks are nowadays available; one of the most popular is the Google Ad Words. This network offers advertisers a wide inventory placed within the Google search results pages. Ad networks provide different levels of user targeting. In this case, AdWords guarantees that customers' advertisements will be only displayed at users who have entered a related key-worded search.

On the other side, on the side of publishers, Google offers the AdSense product which automatically embeds previously provided advertisements within publishers' web pages. The previous provision was carried out by advertisers through the AdWords tool.

Finally, the ad network is in charge of managing the payments advertisers make to publishers. The most common ways in which online advertising is purchased are:
CPM (Cost Per Mille), also called “Cost Per Thousand (CPT), refers to the case wherein advertisers pay for exposure of their message to a specific audience. “Per mille” means per thousand impressions, or loads of an advertisement. However, some impressions may not be counted, such as a reload or internal user action.
CPC (Cost Per Click) is also known as Pay per click (PPC). Advertisers pay each time a user clicks on their listing and is redirected to their website.

Mobile advertising is a form of advertising via mobile phones (http://en.wikipedia.org/wiki/Mobile_advertising). Although related to online or internet advertising, its reach is bigger since the number of mobile phones quintuplicated the amount of computers already in 2007. Mobile media is now rapidly evolving since advertisers are conscious that with the appearance of new smart phones (iPhone, Android series, etc.) together with flat fees mobile browsing is getting popular.

Direct marketing via Short Messaging Service (SMS) push delivery is estimated to count for over 90% of mobile marketing revenue worldwide; however, new forms of advertising such as Multimedia Messaging Service (MMS) advertising, advertising within mobile games and mobile videos, continue appearing.

Mobile web banners are often present within mobile web pages. Four in a row, poster (bottom of page banner) and interstices are formats being delivered by ad servers.

Such formats are used following a series of guidelines published by the Mobile Marketing Association (MMA) throughout the mobile advertising guidelines document. These restricted formats together with the disparity of devices capabilities favoured the apparition of mobile dedicated ad servers.

Referring now to FIG. 2, mobile ad servers 5 contain a series of web pages subject of being rendered according to the capabilities of the device 16, connected to the ad server 5 through a Wireless Application Protocol (WAP) APN 70, requesting [transition 41] the original web page 80. These web pages are the landing pages 81 associated to the web banners 7 which these ad servers also embed. Operators reach agreements with mobile ad servers in order to embed banners into the operator's WAP network pages' inventory.

Some mobile ad servers are also able to target users with proper advertisements according to an anonymous profile previously built out of the browsing logs the user has accumulated. The user is identified by a unique identifier that the operator's WAP network includes in the form of a Hypertext Transfer Protcol (HTTP) header.

As shown, in FIG. 2, after users click on banners [transition 42], the ad server sends back to the user's device a HTTP redirect order [transition 43] to navigate to the landing page 81 [transition 45]. The ad server 5 makes constant usage of these HTTP redirects.

Mobile advertisement companies are now able to carry out new kind of interactions immediately after users click on banners. Most of these interactions, widely referred as click-to-action features, entail carrier capacities [FIG 2, transition 44] in order to, for instance, deliver advert related information via SMS (click-to-SMS), establishing a call between user and advertiser (click-to-call, as disclosed in U.S. 2006/0004627) or printing the route from the current subscriber's cell location to the closest advertiser venue (click-to-route-it as disclosed in U.S. Pat. No. 7,438,215). This kind of actions to be undertaken require obtaining either the subscriber's Mobile Subscriber Integrated Services Digital Network Number (MSISDN) or some kind of subscriber's associated identifier so as to be able to provide the operator in charge of performing the interaction with such information. This information is generally obtained by the ad server out of the HTTP request. Within the HTTP request the ad server receives once the user has clicked on the banner [FIG. 2, transition 42], there is an HTTP header containing the subscriber's MSISDN/Operator Id (e.g. x-up-calling-id). This header is injected by the WAP APN 70 for requests targeting certain sites (e.g. Ad servers 5).

Companies such as Jumptap [http://www.jumptap.com] with its mobile ad server or Yahoo! with its Mobile Ad Services [http://mobile.yahoo.com/business/advertiser] already offer within their catalogue the kind of interactions depicted in the foregoing paragraph to be associated to their inventory ad spaces.

Advertisers belonging to these companies' advertisement network have at their disposal new ways of directly establishing individual channels through their customers' mobile. Moreover, as these actions involving carrier capacities are easily traceable, advertisers increase their ability to meter their return of investment. New generations of mobile phones are arriving equipped with full-html browsers making the Internet browsing experience more similar to the one experienced through a PC or laptop kind of device. This evolution makes browsing through WAP networks not any longer necessary for an increasing number of subscribers. This makes that some of these users may opt to connect through an Internet APN instead of the WAP APN 70.

An Internet APN provides mobile stations (subscriber's mobile phones) with a dynamic public internet address but no http header with subscriber's info is injected within the outgoing http requests. Operators though maintain the ability to recover subscriber's MSISDNs out of the Internet Protocol (IP) address being used by the mobile station. This ability is wrapped within an (Application Programming Interface) API or Lightweight Directory Access Protocol (LDAP) cover and published by operators in order for third party services securely make use of it.

The Gateway GPRS Support Node (GGSN) is a main component of the General Packet Radio Service (GPRS) network. The GGSN is responsible for the interworking between the GPRS network and external packet switched networks, like the Internet. The GGSN is responsible for Internet Protocol (IP) address assignment and is the default router for the connected user equipment (UE). The GGSN also performs authentication and charging functions. Other function includes the IP pool management.

One of the problems is the inability by internet ad servers of carrying out click-to-action sort of interactivities when the user who has clicked the banner is connected through an internet APN. The ad server is able to detect whether the device requesting the advertisement is a mobile phone but, it has no means to resolve the subscriber's id or MSISDN since no http header is injected providing such info. There is no manner for the ad server to have knowledge about the targeted operator's capabilities to carry out the desired action with the subscriber's id they should interact with.

A possible solution would be that the ad servers interrogate the operator through which the incoming request was emitted about which of their subscribers is associated with the incoming http request origin IP address. This, though, is not a trivial task to undertake since ad servers may receive requests for click-to-action from any operator since it is embedding ads within public accessible internet websites. Hence, a mechanism to detect every operator providing internet access service should be employed by every single ad server.

Yet another problem would consist of the ad server featuring click-to-action making use of a different operator for carrying out the action than the one which the target user is subscribed to. This could make the ad server incur in high costs. This problem arises when revenue derived from the delivery of communication is less than the cost of delivering the advertisement to foreign subscribers. Methods to prevent this happening have already been proposed, see U.S. Pat. No. 7,577,433.

### SUMMARY OF THE INVENTION

It would be advantageous to provide a system and method overcoming the drawbacks of the prior art solutions. Thereto, according to the invention a system and a method according to the independent claims are provided. Favourable embodiments are defined in the dependent claims.

Briefly, a system and corresponding method are proposed, which are used by one or more ad servers, and make use of one or more operators and their associated capabilities.

The system's main goal consists of letting subscribers of the operators which the system makes use of, to enjoy those click-to-action kind of interactions which advertisers has decided to place on the Internet through one of the ad servers. Interactions are defined as manners of delivering advertisements entailing one or more operator capabilities.

The ad servers keep storing the advertisements and serving them, but once the user clicks the banner the ad server hands over the control to the system.

The system is responsible of carrying out the post-click action. To make this possible it first has to detect which operator the person who clicked on the banner is subscribed to, following this the subscriber identity is obtained and finally the operator capabilities are leveraged in order to perform the delivery of the interactions by means of e.g. SMS delivery, audio call establishment, etc.

These and other aspects of the invention will be apparent from and elucidated with reference to the embodiments described hereinafter.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 shows a global advertising scenario according to the prior art.

FIG. 2 shows a click-to-action interaction for a terminal connected to a WAP APN according to the prior art.

FIG. 3 shows a global advertising scenario making use of a system according to an embodiment of the present invention.

FIG. 4 shows a click-to-action interaction for a terminal connected to an Internet APN making use of the system according to an embodiment of the present invention.

FIG. 5 shows a block diagram of the system according to an embodiment of the present invention.

FIGS. 6 and 7 show a flowchart of the steps executed by the access module of the system according to an embodiment of the present invention.

FIG. 8 shows a flowchart of the steps executed by the dispatcher module of the system according to an embodiment of the present invention.

FIG. 9 shows a complete click-to-action interaction in detail. Throughout the figures like reference numerals refer to like elements.

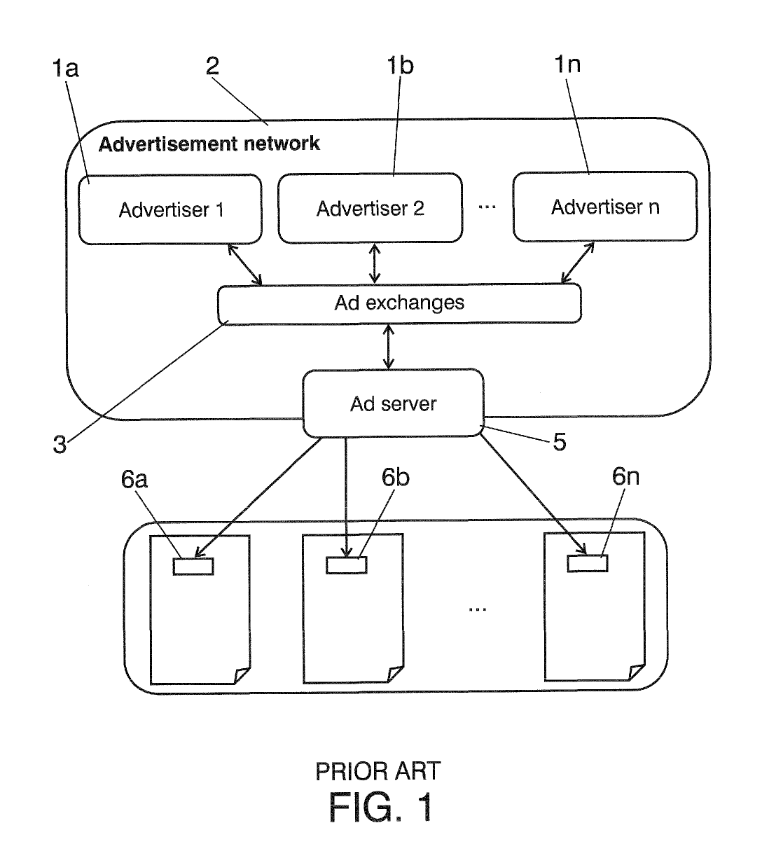

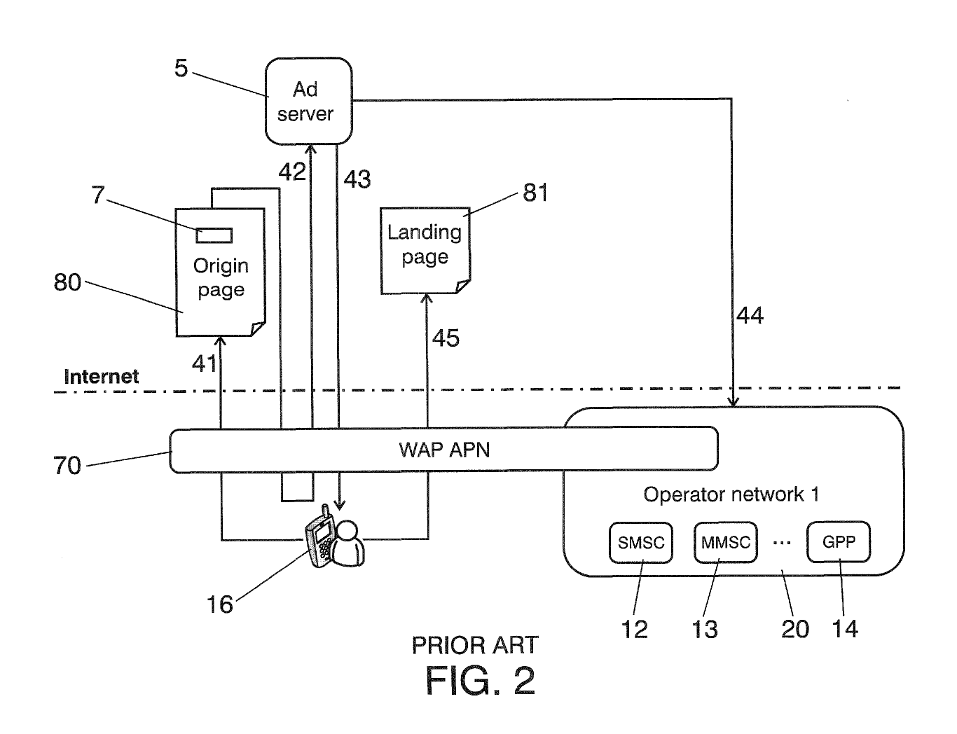

### DETAILED DESCRIPTION OF THE PRESENT INVENTION

An exemplary embodiment will be described of the system for delivering click-to-action interactions according to the invention.

The following assumptions are made:

the banner referred within this section consists of either a web banner or any hyperlink contained within an internet web page. The banner is a Click-to-action type of advertisement. Clicks on such types of advertisement trigger an interaction.

When browsing around those sites containing web banners, the type of connection the user makes use of is an Internet-APN through GPRS/UMTS.

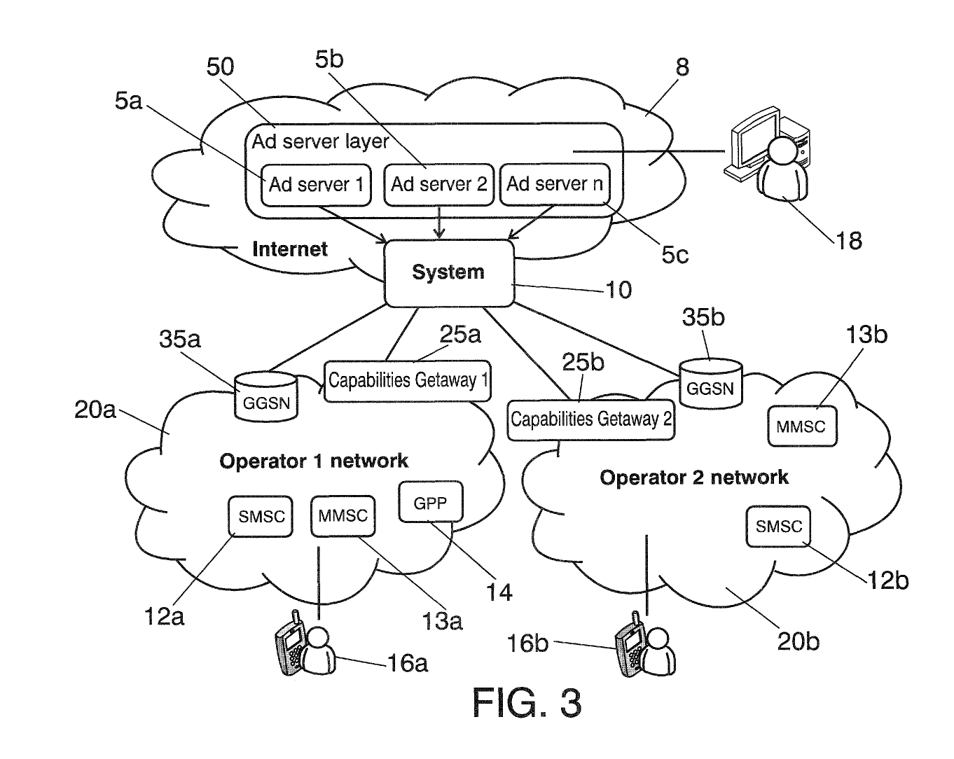

FIG. 3 shows the global scenario wherein the system 10 is situated. Several ad servers 5a-5n, conceptually grouped in the ad server layer 8, are making use of the system 10 in order to associate advertisements hosted by the ad server layer 8 to interactions stored within the system 10. The system 10 is connected to one or more network operators 20a, 20b. By means of these connections, the system is able to access and make usage of some of those operators' 20a, 20b registries 35a, 35b (GGSN nodes) and capabilities, e.g. Short Message Service Centres 12a, 12b for sending SMS messages, Multimedia Message Service Centres 13a, 13b, for sending MMS messages and a Global Positioning Platform 14 (GPP) for geolocationg a subscriber The existence of the system 10 between ad servers 5a-5n and operators 20a, 20b together with the features it takes represent an addition to how click-to-action type of ads are carried out according to the prior art.

An interaction consists of delivering some kind of advertisement to a certain user 16a, 16b making use of an operator's network 20a, 20b. Usage of the communications network may entail capabilities such as voice services, messaging services (Short Message Service, Multimedia Message Service), video telephony services, click-to-call services, download services, subscriber location, among others.

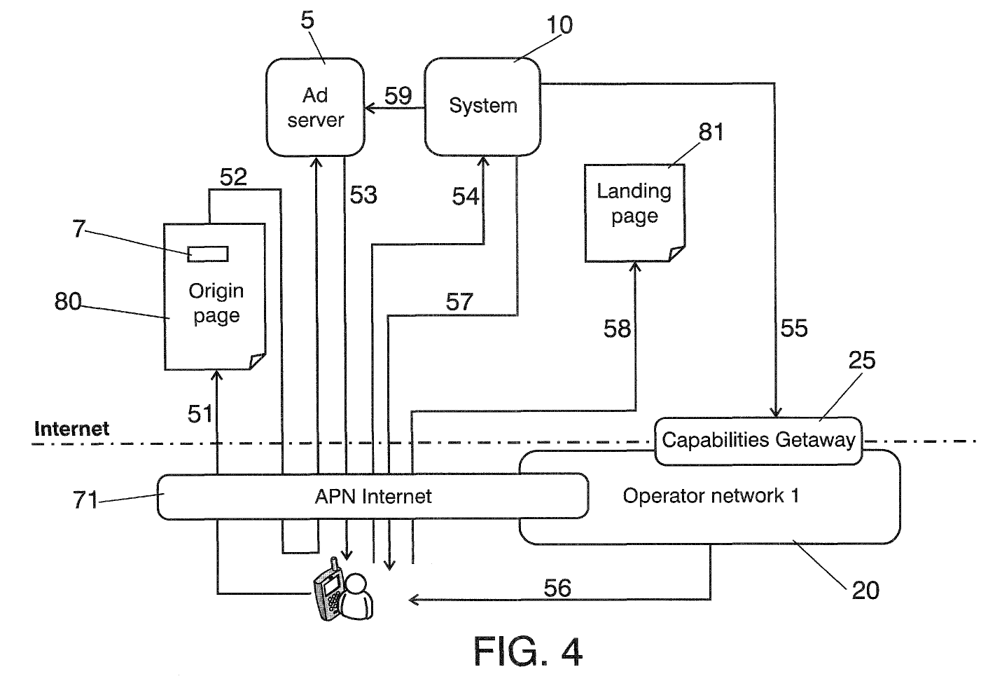

FIG. 4 shows a click-to-action interaction for a terminal connected to an Internet APN 71 making use of the system 10 according to an embodiment of the present invention. A user navigating the Internet at an original page 80 [transition 51] is provided with a banner 7. When clicking on the banner, a HTTP request is sent by the UE to ad server 5 [transition 52] and the ad server provides the UE with an HTTP redirect [transition 53] whose location http response header will be pointing to the external IP address of the system 10. The UE sends a request for interaction [transition 54] to the system 10. The system sends a message [transition 55] to the

capabilities gateway 25a, 25b of the operator network 20a,20b of the UE and the operator network provides the interaction to the UE [transition 56]. While the interaction is being fulfilled, the UE is HTTP redirected towards a final web page. Thereto, a HTTP redirect response from the ad server to the UE [transition 57]. The UE resolves the HTTP redirect and loads the final web page [transition 58].

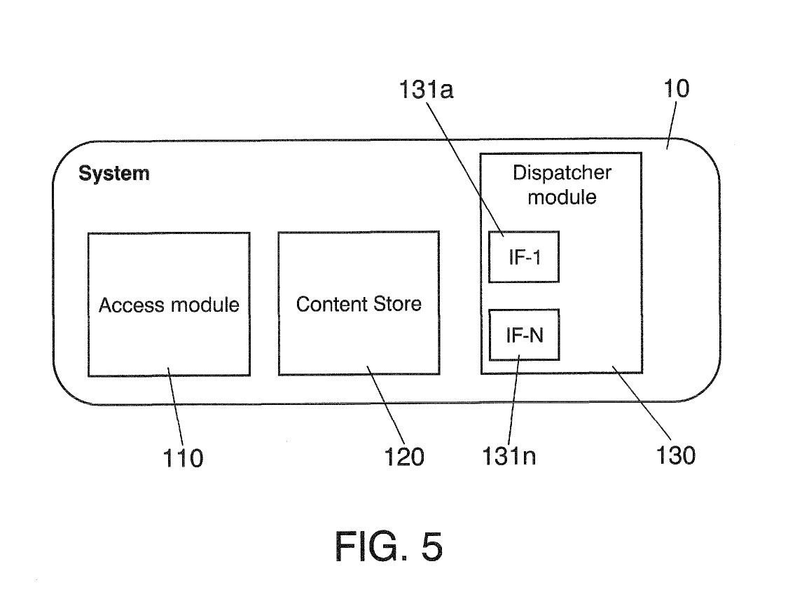

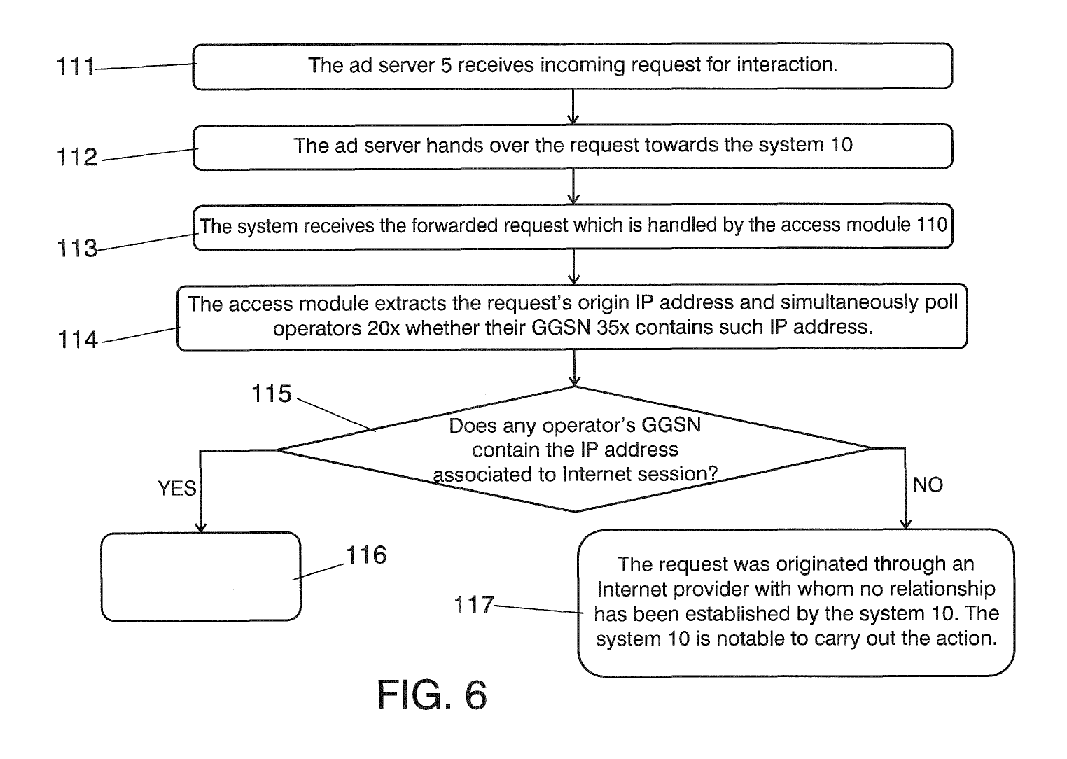

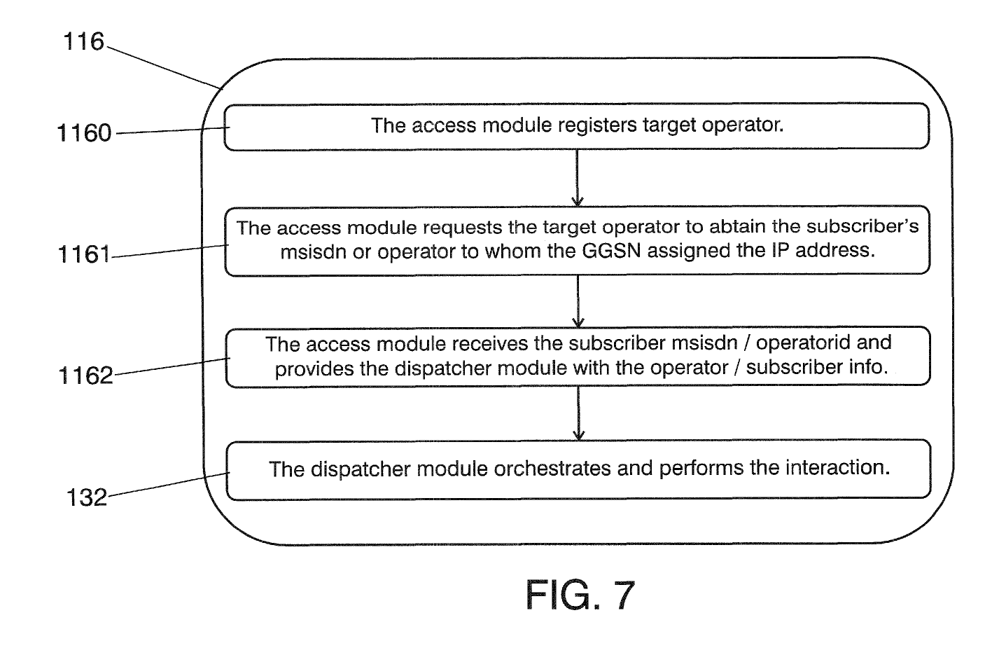

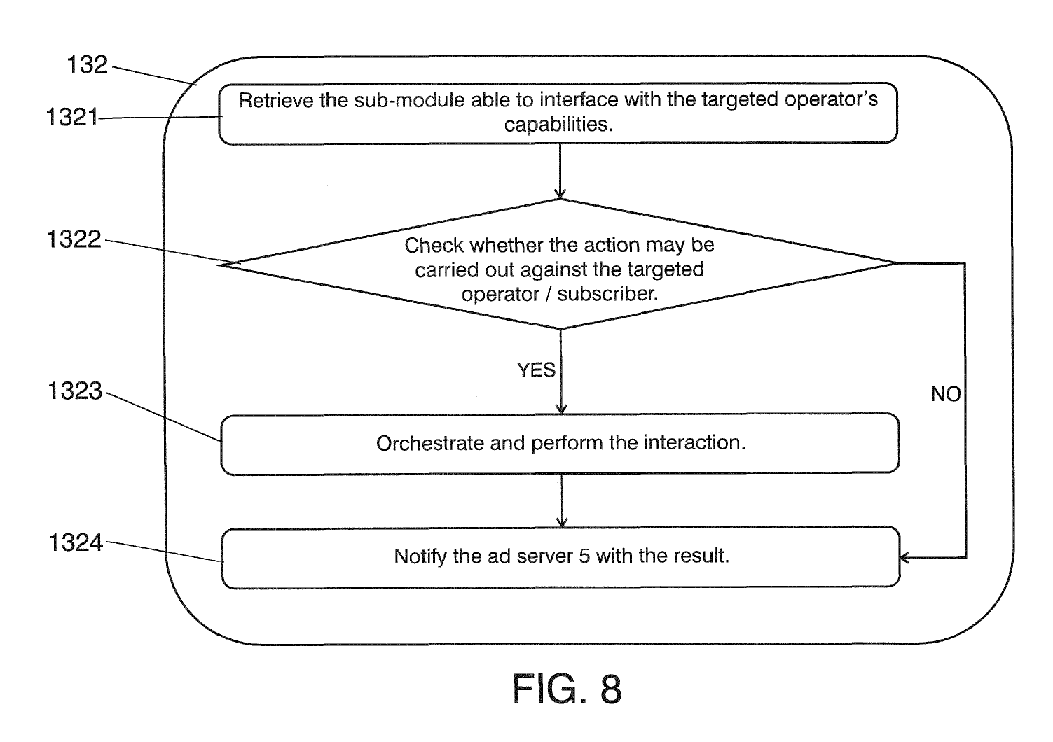

FIG. 5 shows a block diagram of the system 10 according to an embodiment of the present invention. It comprises an access module 110, a content store 120 and a dispatcher module 130.

The system 10 offers the ad server layer 8 a catalogue of interactions it is capable of carrying out. Based on this catalogue, a trafficker 18 (see FIG. 3) provides advertisements with their associated interactions. The system 10 exports an interface by means of which ad servers 5a, 5n provides the system 10 with the advertisement content which must be delivered after users click on the banner. These contents are stored within a module in the system 10: The content store 120 contains any type of communicable message capable of being delivered to a mobile device, including but not limited to the following: an SMS message, an MMS message, a WAP push message; a video to be streamed, an audio to be streamed, maps, routes, etc.

Once the user has clicked on the banner and the request has been received by the ad server 5, (step 111), this, as it has no means to deliver the action hands the request over to the system 10 (step 112). The system receives the forwarded request which is handled by the access module 110. The access module 110 is responsible for obtaining the operator through whose Internet APN 71 the request has been sent. Thereto, the access module simultaneously polls every single operator 20a, 20b the system 10 has established a relationship with (step 114), about whether the request's origin IP address is registered within their GGSN 35 system (step 115). In case no affirmative response is obtained from any operator 20x, the interaction cannot be undertaken (step 117). In case some operator notifies about one of their GGSN 35 containing the IP address, the flow jumps to step 116. The access module registers it as the target operator 20 (step 1160). Subsequently, the access module 110 requests the target operator 20 (step 1161) to identify the subscriber associated to the session assigned with the origin IP address and receives the associated operator ID/MSISDN (step 1162) from the operator network. Once the access module has obtained both the target operator and the subscriber's identity data, the dispatcher module is invoked in order to deliver the advertisement (step 132).

The dispatcher module 130 is in charge of making use of the targeted operator's capabilities in order to deliver the advertiser to the subscriber (step 132). First of all, the dispatcher module 130 retrieves the interface sub-module 131x associated to the targeted operator's capabilities (step 1321). This sub-module contains the information and metadata required (Universal Resource Locators (URLs), protocols, authentication data, etc.) to interface with such operator's capabilities 25.

After the sub-module 130x is loaded, the dispatcher module 130 retrieves the interaction data from the content store 120 and checks (step 1322) whether the targeted interaction is possible to be undertaken based on the available targeted operator's capabilities 25. If there is any required capability not available, the action cannot be undertaken and the ad server 5 is notified of this result (step 1324).

If the required capabilities are available, the interaction is orchestrated and carried out (step 1323) in cooperation with the capabilities gateway 25 embedded within the targeted operator 20. Once the message is delivered to the subscriber, the interaction is finished and the ad server is reported back to. In case any error occurs during the dispatching, the ad server is notified (step 1324).

The embodiments of this invention may be implemented by a combination of hardware, software and middleware together with the needed network communication mediums established among user, telecommunication operators, ad servers and systems.

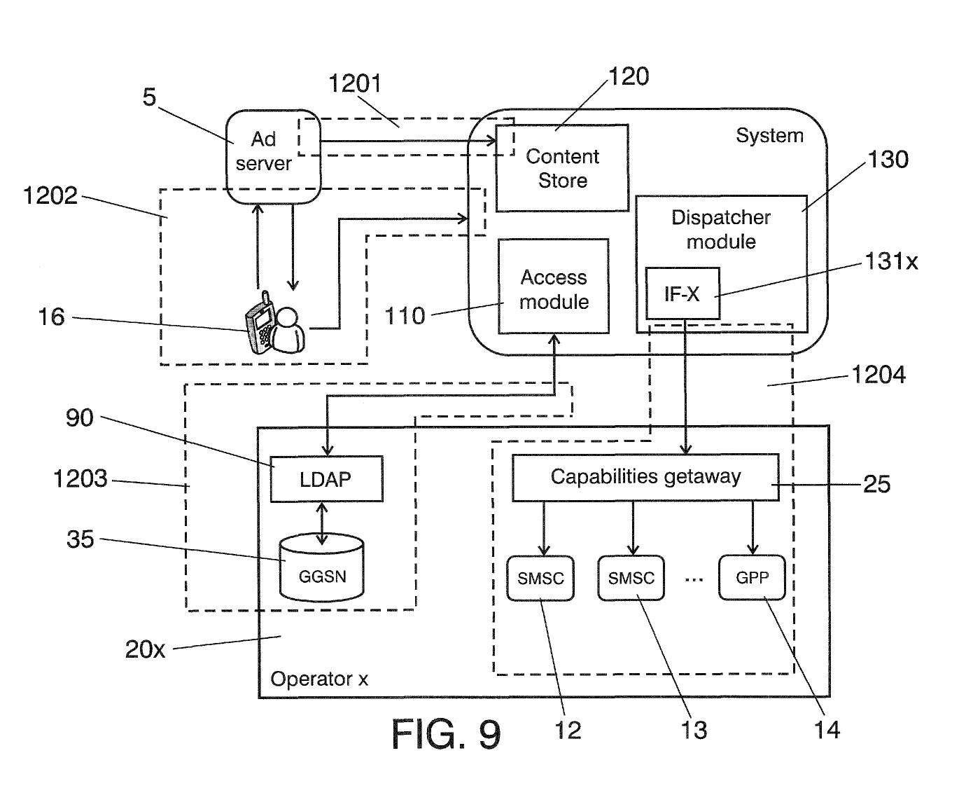

FIG. 9 encompasses all actors, subsystems and modules involved in carrying out a complete click to action event. Four blocks 1201, 1202, 1203 and 1204 are indicated by means of a dashed line as the main functional interactions embodied.

The Click-to-action provisioning block 1201: In one embodiment of the invention the ad server registers the action to be associated with an advertisement through a web service being provided by the content store module 120 contained within the system. The protocol in which the web service is based may be a Simple Object Access Protocol (SOAP)-based one. The content store puts all description and associated contents of the action in a DataBase Management System (DBMS).

The Ad server to system control handover block 1202: When receiving a request for action after the user clicks on the banner, the ad server 5 sends back to the user equipment 16 an HTTP redirect whose location http response header will be pointing to the external IP address of the system 10. The user's mobile device browser completes the HTTP redirection and the system 10 receives the incoming request.

Ascertaining the request's authoring block 1203: In a preferred embodiment a simultaneous request is sent by the access module 110 to every operator the system works with 20x. A process pool is used for accomplishing parallelism. Each process requests a telecommunication operator 20x via a transport protocol e.g. HTTP about whether the click request's origin IP has been assigned by the operator's GGSN 35. It is a common practice among telecommunication operators to wrap the GGSN 35 within a LDAP system 90. In case the GGSN 35 has assigned the targeted IP address, information about the subscriber 16 is retrieved contained within Directory Service Markup Language (DSML) formatted data.

Action dispatching block 1204: The requested ad's associated action is obtained from the content store 120 by the dispatcher module 130 via a database query. This embodiment proposes that metadata containing the catalogue of actions capable of being carried out by the targeted operator 20x as well as their description is persisted via an eXtensible Markup Language (XML) name spaced file 131x. Certain logic must be implemented in order to check whether the action is contained within the catalogue. Actions are requested from a telecommunication operator's capabilities gateway 25 through a SOAP protocol. Services offered by the gateway are built based on a SOA. The gateway 25 provides an abstraction layer to the telecommunication operator's network nodes 12, 13, 14 etc.

The following advantages are obtained by the present invention:

Click-to-action banners available within internet websites. Telecommunication operator's subscribers are able to receive advertisements on their devices 16 as consequence of clicking on an internet website banner while browsing with their mobile equipments via an operator's internet-APN 71. The necessary conditions will be that both ad server 5 and operator 20 are linked to the system subject of the present invention.

Support for multiple ad servers.

Several ad servers 5 at the same time may delegate the delivery of advertisements over telecommunications operator networks 20 to the system 10. This enables subscribers 16 of the operators 20 to enjoy the click-to-action enhancement on every record each ad server 5 contains.

Wider audience for advertisers in click-to-action type of advertisements

Each telecommunication operator 20 which the system comes to make use of enlarges the potential audience of click-to-action advertisement consumers.

Simpler interfaces for ad servers

The system 10, via its dispatcher module 130, interfaces with each telecommunication capabilities gateway 25x. Each gateway has its own peculiarities and protocols. This complex process of integration is transparent for ad servers 5 which employ a single interface against the system in order to deliver advertisements to different operator's subscribers 16.

While the invention has been illustrated and described in detail in the drawings and foregoing description, such illustration and description are to be considered illustrative or exemplary and not restrictive; the invention is not limited to the disclosed embodiments.

In this regard it is to be noted that, the system according to the invention is usable for any scenario wherein the advertisement server does not receive the subscriber identifier of the user (e.g. telephone number) or another fixed user equipment's address and operator to which its user is subscribed.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be

1. A system for causing the delivery of interactions, which are triggered by a user, who is connected to an advertisement server with user equipment via an operator network, selecting an advertisement provided by the advertisement server, the interactions entailing capabilities of the operator network, wherein the advertisement server is not provided with a subscriber identifier of the user, wherein the system is external to the advertisement server and comprises an access module configured for detecting to which operator the user is subscribed, obtaining the subscriber identifier and determining the operator network capabilities in order to deliver the interaction.

2. A system according to claim 1, further comprising a dispatcher module configured for delivering the interaction based on the operator the user is subscribed to, the obtained subscriber identifier and the determined operator network capabilities.

3. A system according to claim 1, wherein the access module is configured for detecting to which operator the user is subscribed, obtaining the subscriber identifier and determining the operator network capabilities based on the dynamic address assigned to the user equipment by the operator network used for sending the request for delivering the interaction.

4. A system according to claim 3, wherein the access module is configured for polling a plurality of operator networks if the dynamic address assigned to the user equipment is registered therein.

5. A system according to claim 4, wherein the access module is configured for registering the operator network used for sending the request for delivering the interaction after receiving a notification thereof that the dynamic address assigned to the user equipment is registered therein.

6. A system according to claim 5, wherein the access module is configured for requesting the registered operator to provide the operator the user is subscribed to and the subscriber identifier.

7. A system according to claim 1, further comprising a content store containing communicable messages capable of being delivered to the user equipment after clicking on a click-to-action type of advertisement.

8. A system according to claim 1, wherein the selection of the advertisement is performed by clicking thereon.

9. A method for the delivery of interactions, which are triggered by a user, who is connected to an advertisement server with user equipment via an operator network, selecting an advertisement provided by the advertisement server, the interactions entailing capacities of the operator network, wherein the advertisement server is not provided with a subscriber identifier of the user, wherein a system external to the advertisement server performs the steps of:
(i) detecting to which operator the user is subscribed,
(ii) obtaining the subscriber identifier;
(iii) determining the operator network capabilities in order to deliver the interaction and
(iv) delivering the interaction based on the operator the user is subscribed to, the obtained subscriber identifier and the determined operator network capabilities.

10. A method according to claim 9, wherein the steps (i), (ii) and (iii) are performed based on the dynamic address assigned to the user equipment by the operator network used for sending the request for delivering the interaction.

11. A method according to claim 10, further comprising the step of polling a plurality of operator networks if the dynamic address assigned to the user equipment is registered therein.

12. A method according to claim 11, further comprising the step of registering the operator network used for sending the request for delivering the interaction after receiving a notification thereof that the dynamic address assigned to the user equipment is registered therein.

13. A method according to claim 12, wherein the steps (i) and (ii) are performed by requesting the registered operator to provide the operator the user is subscribed to and the subscriber identifier.

14. A system according to claim 9, wherein the selection of the advertisement is performed by clicking thereon.

15. A computer program comprising computer program code configured to perform the steps according to claim 9, when said program is run on a computer.
